(19) United States
(12) Patent Application Publication
(10) Pub. No.: US 2010/0192635 A1
(43) Pub. Date: Aug. 5, 2010

(54) MOLDING DIE AND MANUFACTURING METHOD OF OPTICAL ELEMENT

(76) Inventor: Tadafumi Sakata, Hyogo (JP)

Correspondence Address: BRINKS HOFER GILSON & LIONE, P.O. BOX 10395, CHICAGO, IL, 60610, US

(21) Appl. No.: 12/671,409

(22) PCT Filed: Jul. 22, 2008
(86) PCT No.: PCT/JP2008/063113

§ 371 Date: Jan. 29, 2010

(30) Foreign Application Priority Data
Aug. 1, 2007 (JP) 2007-200602

(51) Int. Cl. C03B 11/00

(52) U.S. Cl. 65/66; 65/305

(57) ABSTRACT

A molding die with a simple structure, which produces an optical element of a low eccentricity degree, without narrowing the option for materials of the molding die and a method for producing an optical element by using the molding die are provided. The molding die includes a top die, bottom die, guiding member having a guiding surface kept in contact with the side faces of the top die and bottom die during the press molding of glass material, an expansion member for pressing the top die and bottom die against the guiding surface by thermal expansion by heating, and a supporting member for supporting the guiding member and expansion member. Among these members, the expansion member has the greatest thermal expansion coefficient. The press molding is applied to the glass material while the top die and bottom die are pressed against the guiding member by the thermal expansion of the expansion member.

### TECHNICAL FIELD

The present invention relates to molding dies for manufacturing optical elements by press molding of glass materials, and to the manufacturing method of optical elements using the dies.

### BACKGROUND

Recently, optical elements made of glass are widely being used, such as lenses for digital cameras, optical pick up lenses for DVDs, camera lenses for mobile phones, coupling lenses for optical communication.

It has become more common to manufacture these optical elements made of glass using the press molding method in which a glass material is molded by applying pressure. As a press molding method for optical elements made of glass, conventionally, a method has been known in which in advance a glass material having a prescribed mass and shape is prepared and after heating the glass material along with a molding die, an optical element is obtained by press molding using the molding die.

According to the size reduction and increase in accuracy of various types of optical equipments in recent years, the demanded performance of optical elements made of glass is becoming higher, and even the demanded performance is becoming more severe regarding the quantity of shift of the optical axes of two opposing optical surfaces (hereinafter referred to as “degree of eccentricity”).

In order to reduce the degree of eccentricity of optical elements, a method has been proposed of applying pressure to the peripheral part of the molding die member in a direction perpendicular to the optical axis of the optical element after press molding of optical elements (see Patent Document 1 for example).

Further, as a molding die for reducing the degree of eccentricity, a proposal has been made that pays attention to the thermal expansion coefficients of the materials of the molding dies (see Patent Document 2 for example).

Explanations are given here referring to FIG. 9 about the molding die described in Patent Document 2. FIG. 9 is a diagram showing the cross-sections of the molding dies and the molded optical element described in Patent Document 2. This molding die has a sliding molding die 1, a non-sliding molding die 2, and a body die 3, and the materials of each of the members have been selected so that the relationship α2>α1≧α3 is satisfied when the thermal expansion coefficient of the sliding molding die 1 is α1, the thermal expansion coefficient of the non-sliding molding die 2 is α2, and the thermal expansion coefficient of the body member is α3.

The dimensions are set so that the clearance between the non-sliding molding die 2 and the body die 3 becomes effectively 0 due to the expansion caused by heating to the molding temperature. Further, the dimensions are set so that enough clearance between the sliding molding die 1 and the body die 3 remains in order that sliding is possible. By making these settings in this manner for the thermal expansion coefficients and dimensions of each member, it is said to be possible to aim at reducing the degree of eccentricity of the molded optical elements.

Patent Document 1: Unexamined Japanese Patent Application Publication No. Hei 10-182173

Patent Document 2: Unexamined Japanese Patent Application Publication No. 2005-231933

### DISCLOSURE OF THE INVENTION

### Problems to be Solved by the Invention

However, in the method described in Patent Document 1, it is necessary to control in a complicated manner a plurality of press mechanisms, and there is the problem that this invites the problem of making the manufacturing equipment more complicated and larger in size.

Further, there are various limiting conditions on the materials of the molding die. In particular, it is necessary that the material of the member in the molding die that directly comes into contact with the glass material satisfies a number of conditions such as, that it should resist reaction with glass at high temperatures, should be resistant to oxidization, should allow obtaining a mirror surface, should be easy to work, should be hard and should not be brittle. The materials that actually satisfy all these conditions are limited to some ceramic materials including tungsten carbide, silicon carbide or the like, special heat resistant alloys and others, and it has been difficult to select a material that satisfies the relationship of thermal expansion coefficients given in Patent Document 2.

The present invention was made in view of the above technical problems, and an object of the present invention is to provide a molding die having a simple construction and making it possible to manufacture optical elements with small amounts of eccentricities without narrowing the selecting options of the materials of the molding die, and also, to provide a method of manufacturing optical elements using the molding die.

### Means for Solving the Problems

In order to solve the above problems, the present invention has the following features.

1. A molding die for manufacturing an optical element having two opposing optical surfaces by press molding of a glass material, the molding die including a top die having a first pressure applying surface for forming a first optical surface of the optical element, a bottom die having a second pressure applying surface for forming a second optical surface opposite to the first optical surface, a guiding member having a guiding surface which comes in contact with a side surface of the top die and a side surface of the bottom die at a time of the press molding of the glass material, and restricts relative positions of the top die and the bottom die on a plane which is perpendicular to a direction of pressure application to the glass material, an expansion member for pressing the top die and the bottom die against the guiding surface due to thermal expansion caused by heating, and a supporting member which supports the guiding member and the expansion member, wherein, among thermal expansion coefficients of the top die, the bottom die, the guiding member, the expansion member and the supporting member, a thermal expansion coefficient of the expansion member is largest.

2. The molding die of the above item 1, wherein the supporting member is a cylindrical member having an internal peripheral surface, and the guiding member and the expansion member are supported by the internal peripheral surface of the supporting member.

3. The molding die of the above item 1 or 2, wherein one of the top die and the bottom die is a movable die which moves in the direction of pressure application to the glass material at the time of the press molding and another is a fixed die which does not move at the time of the press molding, the expansion member has a top expansion member for pressing the top die and a bottom expansion member for pressing the bottom die, and pressing force of pressing the movable die due to the thermal expansion of the expansion member is smaller than pressing force of pressing the fixed die.

4. The molding die of any one of the above items 1 to 3, wherein the guiding member has two of the guiding surfaces positioned in a shape of a letter V.

5. The molding die of any one of the above items 1 to 4, wherein the side surface of the top die and the side surface of the bottom die which come in contact with the guiding surface are cylindrical surfaces of substantially identical diameters.

6. The molding die of the above item 5, wherein the top die is one on which the first pressure applying surface is formed, among two die base materials obtained by cutting one cylindrical member, and the bottom die is another on which the second pressure applying surface is formed, among the two die base materials.

7. A manufacturing method of optical element for manufacturing an optical element having two opposing optical surfaces by press molding of a glass material using a molding die, wherein the molding die is of any one of the above items 1 to 6, and the press molding is applied to the glass material in a condition in which the top die and the bottom die are pressed against the guiding surface of the guiding member due to the thermal expansion of the expansion member.

8. The manufacturing method of optical element of the above item 7, wherein an angle between a direction from a center of the side surface of the top die towards a center of the first pressure applying surface and a direction from a center of the side surface of the bottom die towards a center of the second pressure applying surface on the plane perpendicular to the direction of pressure application at the time of the press molding of the glass material is less than 60°.

### EFFECTS OF THE INVENTION

According to the present invention, because the glass material is press-molded in the condition in which the top die and the bottom die are pushed and pressed against guiding members due to the thermal expansion of an expansion member, it is possible to effectively suppress any position shift of the top die and the bottom die. As a consequence, it is possible to manufacture optical elements with a simple configuration and with small degrees of eccentricities without having to narrow the selecting options of the materials of the molding dies.

### BRIEF DESCRIPTION OF THE DRAWINGS

FIG. 1 is a diagram showing an example of molding die according to the first preferred embodiment of the present invention.

FIG. 2 is a diagram showing an example of molding die according to the second preferred embodiment of the present invention.

FIG. 3 is a diagram showing the molding die 20a that is a modified example of the molding dies according to the present invention.

FIG. 4 is a diagram showing the molding die 20b that is a modified example of the molding dies according to the present invention.

FIG. 5 is a diagram showing the molding die 20c that is a modified example of the molding dies according to the present invention.

FIG. 6 is a diagram showing the preferred method of manufacturing the top die 11 and the bottom die 12.

FIG. 7 is a flow chart showing an example of the method of manufacturing optical elements according to the present invention.

FIG. 8 is a diagram schematically showing the positional relationship between the top die 11 and the bottom die 12.

FIG. 9 is a diagram showing the cross-section of a conventional molding die.

### EXPLANATION OF SYMBOLS

10 Molding die
11 Top die
11c First pressure applying surface
11s Side surface of top die
12 Bottom die
12c Second pressure applying surface
12s Side surface of bottom die
13 Guiding member
13s Guiding surface of guiding member 13
14 Expansion member
15 Supporting member
16 Cylindrical member
20, 20a, 20b, 20c Molding dies
23 Guiding member
23a, 23b Guiding surfaces of guiding member 20
24U Top expansion member
24L Bottom expansion member
31, 32 Glass material
110 Top die base material (molding die base material)
120 Bottom die base material (molding die base material)
C11 Center of first pressure applying surface 11c
C12 Center of second pressure applying surface 12c

### DESCRIPTIONS OF THE PREFERRED EMBODIMENTS

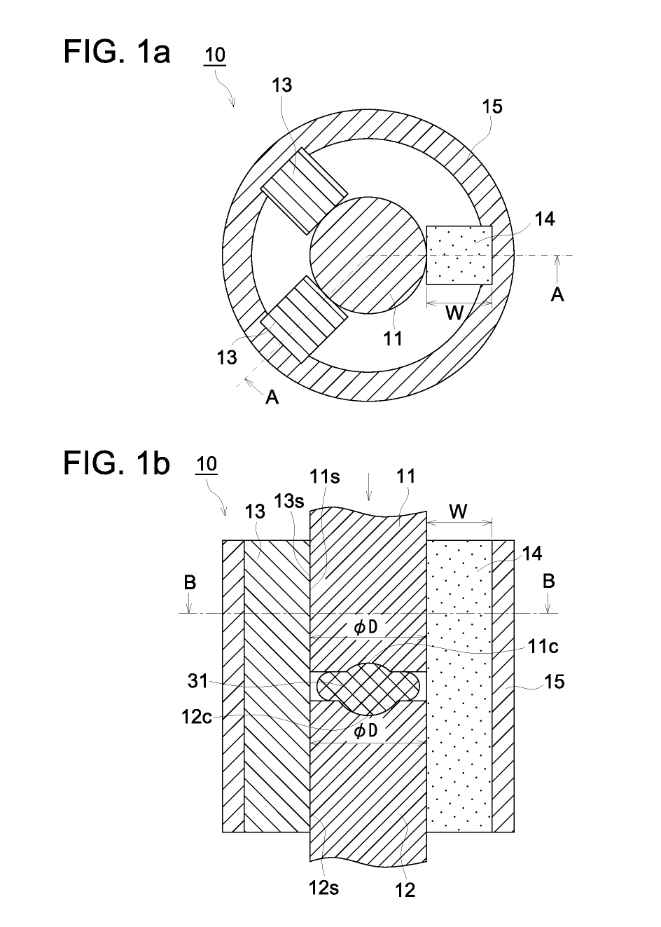

Some preferred embodiments of the present invention are described in detail below while referring to FIGS. 1 to 8.

### First Preferred Embodiment

FIG. 1 is a diagram showing an example of a molding die according to the first preferred embodiment of the present invention, and shows the condition in the process of applying pressure to the glass material. FIG. 1a is a cross-sectional view diagram of a cross-section perpendicular to the direction of pressing (the press axis direction) the glass material and indicates the cross-section at B-B indicated in FIG. 1b. Further, FIG. 1b is a cross-sectional view diagram of a cross-section that is parallel to the press axis direction and indicates the cross-section at A-A indicated in FIG. 1a.

The molding die 10 shown in FIG. 1 has a top die 11, a bottom die 12, a guiding member 13, an expansion member 14, and a supporting member 15.

The top die 11 has the first pressure applying surface 11c that has been machined precisely with a shape corresponding to the first optical surface of the optical element and the bottom die 12 has the second pressure applying surface 12c that has been machined precisely with a shape corresponding to the second optical surface opposing to the first optical surface. The top die 11 is a movable die constructed so that it can be moved in the pressure applying direction (the direction of the arrow in FIG. 1b) by a driving device not shown in the figure, and the bottom die 12 is a fixed die that does not move at the time of press molding. An optical element having two opposing optical surfaces is obtained by moving the top die 11 downward and by applying pressure to the glass material 31 in the softened state by the first pressure applying surface 11c and the second 12c.

Further, the top die 11 and the bottom die 12 respectively have the cylindrical side surfaces 11s and 12s, and it is desirable that the side surfaces 11s and 12s are machined to be roughly of the same diameter. Here, “same diameter” implies that the diameters are equal, but it is not necessary that the difference between the diameters of the side surface 11s and the side surface 12s is strictly 0. It is sufficient if that difference is less than a value according to the tolerable width of the degree of eccentricity that is required of the optical element. For example, in case the tolerable width of the degree of eccentricity (the degree of shift of the optical axes of the two opposing optical surfaces) is 5 μm, it is sufficient if the difference between the diameters of the side surfaces 11s and 12s is less than or equal to 10 μm, and if the tolerable width of the degree of eccentricity is 2 μm, it is sufficient if the difference between the diameters of the side surfaces 11s and 12s is less than or equal to 4 μm.

The guiding member 13 has a guiding surface 13s for, at the time of press molding of the glass material 31, coming in contact with the side surface 11s of the top die 11 and the side surface 12s of the bottom die 12, and restricting the relative positions of the top die 11 and the bottom die 12 within a surface perpendicular to the direction of the press axis, and is supported by the internal peripheral surface of the cylindrical shaped supporting member 15. As has been described above, since the diameters of the side surface 11s and the side surface 12s are equal, by making the side surface 11s and the side surface 12s come in contact with the guiding surface 13s together, it is possible to effectively suppress the position shift of the top die 11 and the bottom die 12.

While the molding die 10 is restricting the relative positions of the top die 11 and bottom die 12 using two guiding members 13, the construction of the guiding member 13 is not restricted to this. For example, it is also possible to use a guiding member having a plurality of guiding surfaces constructed in an integral manner and made to come in contact with the top die and the bottom die, or else, it is also possible to have a construction in which the top die 11 and the bottom die 12 are made to come in contact with three or more guiding surfaces.

The expansion members 14 are the ones for making the top die 11 and the bottom die 12 press against the guiding surface 13s due to thermal expansion caused by heating, and are supported by the internal peripheral surface of the supporting member 15.

In the molding die 10, the materials of the members are selected so that the thermal expansion coefficient of the expansion member 14 is the largest among the thermal expansion coefficients of the top die 11, the bottom die 12, the guiding member 13, the expansion member 14, and of the supporting member 15. Because of this, in the process of heating the molding die 10 for softening the glass material 31, due to the thermal expansion of the expansion member 14, the top die 11 and the bottom die 12 get pressed against the guiding member 13. After that, in the condition in which the top die 11 and the bottom die 12 are kept in contact with the guiding member 13, by applying pressure on the glass material 31 by moving the top die 11 downward, an optical element with a small degree of eccentricity can be manufactured.

Further, although strictly speaking the thermal expansion coefficient differs depending on the temperature, in the present invention, this is the average thermal expansion coefficient from the instant of time of starting to heat after placing the glass material between the top die 11 and the bottom die 12 until the instant of time when pressure is applied to the glass material 31 after heating.

Various physical characteristics are required of the materials for the top die 11 and the bottom die 12, such as, resisting reaction with glass at high temperatures, resistance to oxidization, obtaining a good mirror surface. As the materials having these physical characteristics, for example, it is possible to consider cemented carbide having tungsten carbide as the main constituent, various types of ceramics such as carbide and nitride (silicon carbide, silicon nitride, aluminum nitride), carbon, or their composite materials. Further, it is also desirable to form thin films of various types of metals, ceramics, carbon and others, on the surface of such materials. The same material or different materials can be used for the top die and the bottom die.

Further, although the guiding member 13 and the supporting member 15 do not come into direct contact with high temperature glass, since they are required to have resistance to oxidization at high temperatures and durability, it is desirable to use a material similar to the materials used for the top die 11 and bottom die 12.

A material having a larger thermal expansion coefficient than the materials used for the top die 11, bottom die 12, guiding member 13, or supporting member 15 is used for the expansion member 14. For example, it is possible to use stainless steel, titanium alloys, or nickel based or cobalt based heat resistant alloys. Among stainless steels, it is particularly desirable to use SUS303, SUS304, SUS310S, SUS316, or the like, which are austenite type stainless steels, since they have relatively larger thermal coefficients of expansion than other types of stainless steels.

The thermal expansion coefficient of the examples of materials given above as materials used for the top die 11 and the bottom die 12 is normally less than 10×10⁻⁶/K. For example, the thermal expansion coefficient is about 6×10⁻⁶/K for cemented carbide having tungsten carbide as the main constituent, and about 4×10⁻⁶/K for silicon carbide. In contrast with this, the thermal expansion coefficients of stainless steels are larger than 10×10⁻⁶/K, and in particular, it is extremely high of austenite type stainless steels, being about 18×10⁻⁶/K.

Because of this, by constituting the expansion member 14 using a material having a large thermal expansion coefficient such as stainless steel, for the top die 11 and the bottom die 12, from the example of materials given above, an appropriate material according to the different conditions can be selected. As a consequence, it is possible to manufacture optical elements with a simple configuration and with small degrees of eccentricities without having to narrow the selecting options of the materials of the top die 11 and the bottom die 12.

Further, so that the top die 11 and the bottom die 12 are pressed against the guiding surface 13s due to the thermal expansion of the expansion member 14, it is necessary to appropriately set the gap between the expansion member 14 and the top die 11 (or the bottom die 12) according to the conditions such as the thermal expansion coefficients of different members or the heating temperature.

For example, in the molding die 10 of FIG. 1, now the case is considered in which the top die 11, the bottom die 12, the guiding member 13, and the supporting member 15 are all constituted of silicon carbide (thermal expansion coefficient: 4×10⁻⁶/K) and the expansion member 14 is constituted of SUS304 (thermal expansion coefficient: 18×10⁻⁶/K). It is assumed that the temperature at the time of placing the glass material between the top die 11 and the bottom die 12 and starting the heating is 25° C. and the temperature after heating and at the time of applying pressure to the glass material is 500° C. Further, it is assumed that the length (W) of the expansion member 14 in the radial direction is 10 mm. In this case, at the time the top die 11 is made to come in contact with two guiding surfaces 13s, if the gap present between the top die 11 and the expansion member 14 is less than or equal to 66 μm, the top die 11 is pressed against the guiding member 13 when heated to 500° C.

### Second Preferred Embodiment

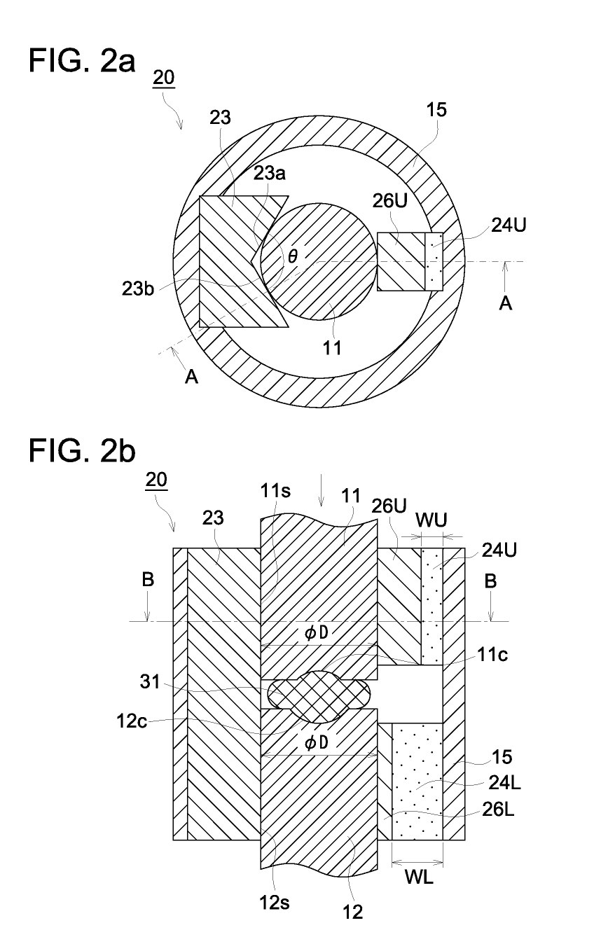

FIG. 2 is a diagram showing an example of a molding die according to the second preferred embodiment of the present invention, and shows the condition in the process of applying pressure to the glass material. FIG. 2a is a cross-sectional view diagram of a cross-section perpendicular to the direction of pressing the glass material (the press axis direction) and indicates the cross-section at B-B indicated in FIG. 2b. Further, FIG. 2b is a cross-sectional view diagram of a cross-section that is parallel to the press axis direction and indicates the cross-section at A-A indicated in FIG. 2a.

The molding die 20 shown in FIG. 2 is different from the molding die 10 described above in that the guiding member 23 is constituted of a V-block, the expansion member is made of a top expansion member 24U and a bottom expansion member 24L which respectively press against the top die 11 and the bottom die 12 via the spacers 26U and 26L. Since all other aspects of construction are similar to the molding die 10, the same symbols are assigned to identical structural elements and their explanations will be omitted.

The guiding member 23 of the molding die 20, is a so called V-block, and has two guiding surfaces 23a and 23b placed in the shape of the letter V. Because of a structure like this, changes in the positional relationship between the two guiding surfaces 23a and 23b can be prevented, and since it is not necessary to precisely adjust the position or the angle of the guiding surfaces every time a molding die is set, it becomes possible to manufacture optical elements more efficiently with a small degree of eccentricity.

Although there is no particular restriction on the angle θ between the guiding surface 23a and the guiding surface 23b, it is desirable that the angle is 10° to 170° in order to restrict stably the relative positions of the top die 11 and the bottom die 12, and it is more desirable that the angle is 30° to 150°.

In the molding die 20, the top die 11 is a movable die that moves in the direction of applying pressure (in the direction of the arrow in FIG. 2b) at the time of press molding, and the bottom die 12 is a fixed die that does not move at the time of press molding. At the time of press molding, it is necessary that the bottom die 12 that is a fixed die is pressed against the guiding surfaces 23a and 23b with a sufficient pressing force. On the other hand, if the pressing force to the top die 11 as the movable die pressed against the guiding surfaces 23a and 23b is too strong, the frictional force between the die and the guiding surfaces 23a and 23b becomes too large, and the movement for applying pressure to the glass material 31 may not be made smoothly. Because of this, it is desirable that the pressing force of the top die 11 (the movable die) is made smaller than the pressing force of the bottom die 12 (the fixed die). However, in order to suppress the position shift of the top die 11 and the bottom die 12, the top die 11 needs to be pressed with a pressing force that allows at least press molding to be carried out in the condition in which the top die 11 is kept in contact with the guiding surfaces 23a and 23b.

In order to make the pressing force of pressing the top die 11 smaller than the pressing force of pressing the bottom die 12, the expansion member of the molding die 20 has a top expansion member 24U for pressing the top die 11 and a bottom expansion member 24L for pressing the bottom die 12. Since the thickness WU of the top expansion member 24U is smaller than the thickness WL of the bottom expansion member 24L, the amount of expansion due to heating of the top expansion member 24U is smaller and the pressing force also becomes smaller.

Further, in the molding die 20, the expansion members are not made to come in contact with the top die 11 and the bottom die 12 directly, but press against the top die 11 and the bottom die 12 via the spacers 26U and 26L. By having a structure like this, the thickness WU of the top expansion member 24U and the thickness WL of the bottom expansion member 24L can be adjusted to any desired value, and fine adjustment of the pressing force can be easily carried out.

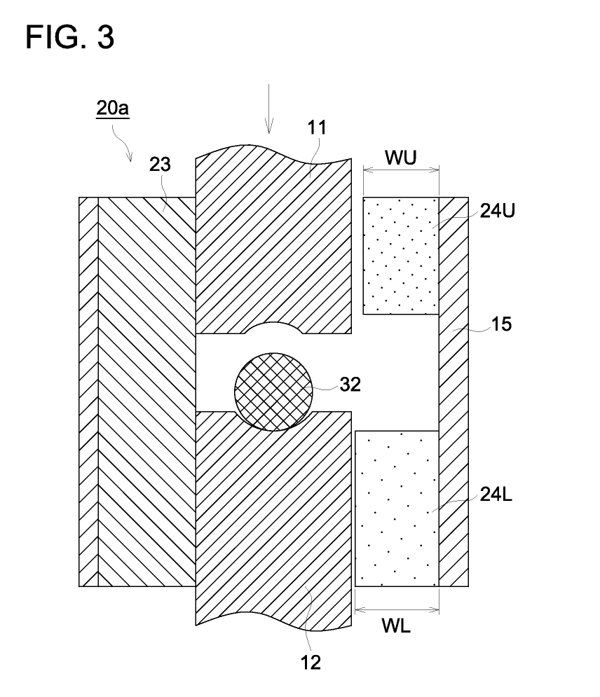

The structure for making the pressing force of pressing the top die 11 smaller than the pressing force of pressing the bottom die 12 is not limited to this. FIGS. 3 to 5 are diagrams showing molding dies 20a, 20b, and 20c, which are modified examples of the molding die.

FIG. 3 is the state at the instant of time when the glass material 32 is placed in the molding die 20a, and shows the condition before starting the heating. Unlike the molding die 20, this structure is such that the top expansion member 24U and the bottom expansion member 24L directly keep in contact with and press the top die 11 and the bottom die 12. The thickness WU of the top expansion member 24U is smaller than the thickness WL of the bottom expansion member 24L, and before starting the heating, the gap with the top die 11 is larger than the gap with the bottom die 12. Because of this, at the time of press molding of the glass material 32 after heating, the pressing force of pressing the top die 11 becomes smaller than the pressing force of pressing the bottom die 12.

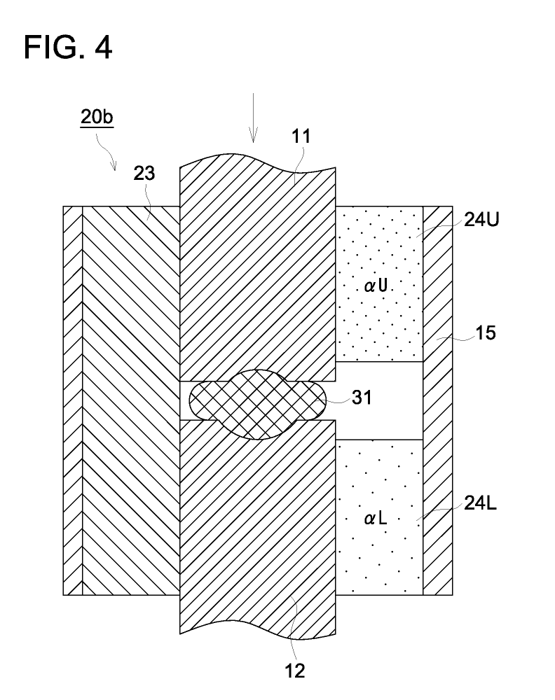

FIG. 4 shows the condition in which the glass material 31 is being press-molded by the molding die 20b. Unlike the molding die 20a, the top expansion member 24U and the bottom expansion member 24L have the same thicknesses. However, the top expansion member 24U and the bottom expansion member 24L have been formed of materials having different coefficients of thermal expansion, and the thermal expansion coefficient αU of the top expansion member 24U is smaller than the thermal expansion coefficient αL of the bottom expansion member 24L. Because of this, the amount of expansion due to heating is smaller for the top expansion member 24U than for the bottom expansion member 24L, and hence it is possible to make the pressing force of pressing the top die 11 smaller than the pressing force of pressing the bottom die 12.

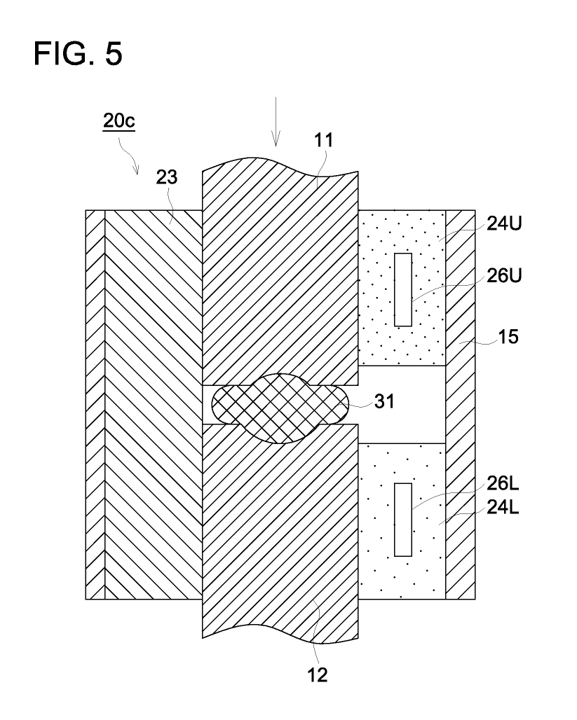

FIG. 5 shows the condition in which the glass material 31 is being press-molded by the molding die 20c. The top expansion member 24U and the bottom expansion member 24L of the molding die 20c have heaters 26U and 26L internally, and each of them can be heated to independent temperatures. The thicknesses of the top expansion member 24U and the bottom expansion member 24L are the same before heating, and they also have the same coefficients of thermal expansion. By adjusting the set temperatures of the heaters 26U and 26L, and by making the heating temperature of the top expansion member 24U smaller than the heating temperature of the bottom expansion member 24L, the amount of thermal expansion of the top expansion member 24U becomes smaller, and it becomes possible to make the pressing force of pressing the top die 11 smaller than the pressing force of pressing the bottom die 12.

(Method of Manufacturing the Top Die 11 and Bottom Die 12)

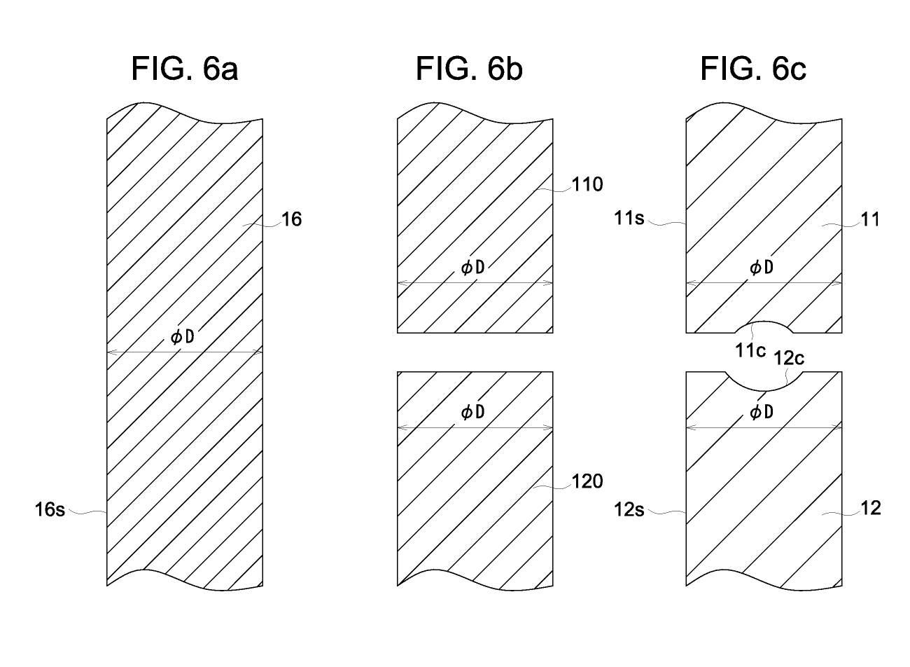

FIG. 6 is a diagram showing an example of a preferable method of manufacturing the top die 11 and the bottom die 12.

As has been described above, it is desirable that the machining is done so that the side surface 11s of the top die 11 and the side surface 12s of the bottom die 12 have roughly the same diameters. In the case of this type of structure, the difference between the diameters of the side surface 11s and the side surface 12s affects the degree of eccentricity of the optical element that has been manufactured. According to the method shown in FIG. 6, the top die 11 and the bottom die 12 can be efficiently manufactured with a small difference in the diameters of the side surface 11s and the side surface 12s.

To begin with, the side surface 16s of one cylindrical member 16 is machined and finished to a prescribed diameter (φD) (FIG. 6a). Next, the cylindrical member 16 is cut at right angles to the axis thereby preparing two die base materials (top die base material 110 and bottom die base material 120) (FIG. 6b). After that, the first pressure applying surface 11c for forming the first optical surface of the optical element and the second pressure applying surface 12c for forming the second optical surface opposite to the first optical surface are formed by precision machining, thereby the top die 11 and the bottom die 12 are obtained (FIG. 6c).

The side surface 11s of the top die 11 and the side surface 12s of the bottom die 12 are surfaces which are the same as the side surface 16s left as it is after it is formed by machining the cylindrical member 16 before cutting, and the diameters of the side surface 11s and the side surface 12s are both equal to φD. Therefore, according to a method like this, a top die 11 and a bottom die 12 with an extremely small difference in the diameters can be efficiently manufactured.

Further, there is no problem in adding further machining to the side surface 11s of the top die 11 and the side surface 12s of the bottom die 12 after the cutting, within a range in which there is no effect on the diameters. For example, it is also possible to carry out polishing for reducing the surface roughness within a range that does not affect the diameters, or to carry out processing for forming thin films for protection.

(Method of Manufacturing Optical Elements)

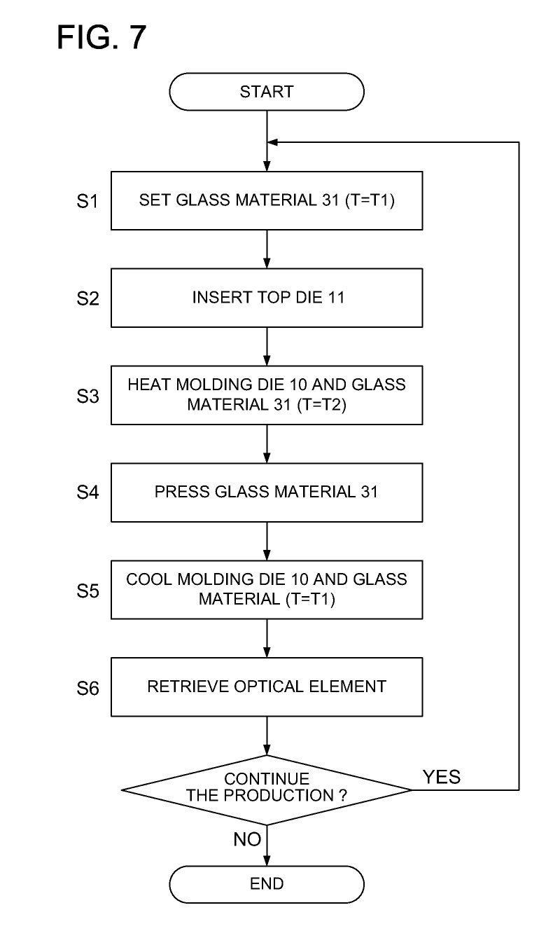

FIG. 7 is a flow chart showing an example of the method of manufacturing optical elements according to the present invention. In the following, referring to FIG. 1 and FIG. 7, a method of manufacturing optical elements using the molding die 10 is described.

To begin with, in the condition in which the top die 11 is retracted upward, a glass material 31 is placed on the second pressure applying surface 12c of the bottom die 12 (S1). The shape of the glass material 31 can be suitably selected according to the shape and others, of the optical element to be manufactured. For example, spherical, hemispherical, flat shapes can be used. Further, there is no particular restriction on the material of the glass material 31 to be used, and it is possible to select and use any widely known glass according to the use. For example, optical glasses such as borosilicate glass, silicate glass, phosphate glass, lanthanum system glass can be used.

At this time, the temperature (T) of the molding die 10 is maintained at a prescribed temperature (T1) that is lower than the temperature (T2) at the time of press molding. If the temperature of the molding die 10 is too high, there is the likelihood that it becomes difficult to insert the top die 11 next time due to the thermal expansion of the expansion member 14, and if the temperature is too low, a long time becomes necessary for heating and cooling and hence the productivity may become poor. Normally, it is sufficient to set the temperature suitably from about the room temperature (25° C.) to a temperature less than the glass transition temperature (Tg) of the glass material 31.

Next, the top die 11 is lowered and inserted between the guiding member 13 and the expansion member 14 (S2). At this time, the temperature of the molding die 10 is T1, and since the expansion member 14 has not yet expanded, the top die 11 and the bottom die 12 are not pushed against the guiding member 13.

In this condition, using a heating apparatus not shown in FIG. 1, the molding die 10 and the glass material 31 are heated to the temperature (T2) which is the temperature at the time of press molding (S3). Because of thermal expansion due to heating, the top die 11 and the bottom die 12 are pushed against the guiding surface 13s of the guiding member 13.

The temperature (T2) at the time of press molding can be appropriately selected to a temperature at which a good transferred surface can be formed on the glass material 31 due to press molding. In general, if the temperature of the top die 11 and the bottom die 12 is too low, it is difficult to form a good transfer surface on the glass material 31. On the contrary, if the temperature is higher than is necessary, fusion bonding may occur between the glass and molding die, or the life of the molding die may become short. In actuality, since the appropriate temperature varies depending on various conditions such as the type, shape, or size of glass, the material of the molding die, type of protective film, shape and size of the glass material, position of the heater or the temperature sensor, it is desirable to obtain the appropriate temperature by experimenting.

Further, there is no particular restriction on the heating apparatus and any well known heating apparatus can be used. Examples can be given, such as an infrared heating apparatus, a high frequency induction heating apparatus, cartridge heater. In addition, in order to prevent each member of the molding die 10 from deteriorating due to oxidization caused by heating, it is desirable that the entire molding die 10 is sealed and nitrogen gas or argon gas are introduced, and to heat in a non-oxidizing atmosphere. It is also possible to heat in a vacuum environment.

Next, using a driving section not shown in the figures, the top die 11 is lowered and pressure is applied on the glass material 31 (S4). Because of this, the first pressure applying surface 11c of the top die 11 and the second pressure applying surface 12c of the bottom die 12 are transferred to the glass material 31 thereby forming an optical element having two opposing optical surfaces. The force of applying pressure can be suitably set depending on the size or the like of the glass material 31. In addition, the force of applying pressure may be changed with time.

There are no restrictions even on the driving section, and it is possible to select and appropriately use any well known pressure applying section such as an air cylinder, a hydraulic cylinder, an electrically driven cylinder using a servo motor.

After that, the molding die 10 and the glass material 31 are cooled down to the initial temperature (T1) (S5). In the middle of cooling, at the time when the temperature has been reached at a temperature where the shape of the transferred surface is not disturbed even if the application of pressure to the glass material 31 is released, the application of pressure is released by separating the top die from the glass material. Although the temperature at which the application of pressure is released depends on the type of glass, size and shape of the glass material, the necessary accuracy and others, normally, it is sufficient if it is cooled to near the glass transition temperature (Tg).

When the molding die 10 is cooled down to the initial temperature (T1), the top die 11 is retracted upwards and the produced optical element is collected (S6). The collection of the optical element can be carried out using a publicly known die releasing apparatus using vacuum suction, or the like. After that, if the manufacturing of optical elements is to be continued, it is sufficient to repeat the processes of steps S1 to S6.

Further, the method of manufacturing optical elements according to the present invention can also have processes other than those described here. For example, it is also possible to provide processes such as a process of inspecting the shape of the optical element before it is collected, or a process of cleaning the molding die 10 after collecting the optical element.

Here, it is difficult to make the center of the side surface 11s of the top die 11 coincide exactly with the center of the first pressure applying surface, and in actuality, often a slight shift is generated due to limitations in machining. This can be said about the bottom die 12 also. In such cases, even if the center of the side surface 11s of the top die 11 and the center of the side surface 12s of the bottom die 12 are made to coincide with each other at the time of press molding, a slight shift may remain between the center of the first pressure applying surface 11c and the second pressure applying surface 12c, and a small amount of shift in the optical axes may remain even in the manufactured optical element.

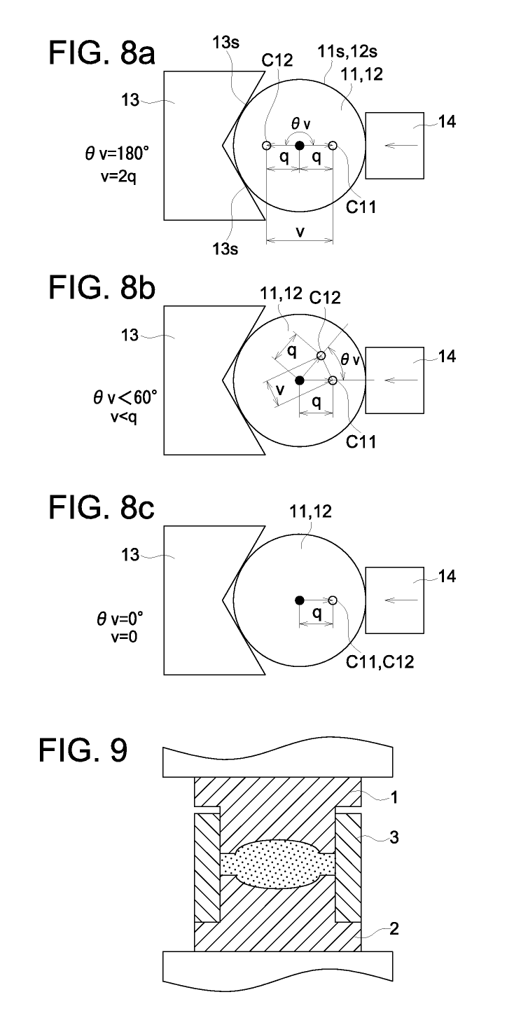

FIG. 8 is a diagram schematically showing the positional relationship between the top die 11 and the bottom die 12 within a surface that is perpendicular to the direction of applying pressure at the time of press forming of a glass material, and is a diagram of a view from above of the top die 11, the bottom die 12, the guiding member 13, and the expansion member 14. Due to the thermal expansion of the expansion member 14, the top die 11 and the bottom die 12 are being pressed against the guiding surface 13s of the guiding member 13, and the center of the side surface 11s of the top die 11 is coinciding with the center of the side surface 12s of the bottom die 12.

As is shown in FIG. 8, when there is a shift between the center of the side surface 11s and the center of the first pressure applying surface 11c, and, when there is a shift between the center of the side surface 12s and the center of the second pressure applying surface 12c, depending on the relative positional relationship between the top die 11 and the bottom die 12, and there is a difference in the amount of shift (the amount of shift “v” of the centers of the pressure applying surfaces) between the center C11 of the first pressure applying surface 11c and the center C12 of the second pressure applying surface 12c.

For the sake of simplicity, the amount of shift between the center of the side surface 11s and the center C11 of the first pressure applying surface 11c, and the amount of shift between the center of the side surface 12s and the center C12 of the second pressure applying surface 12c, are both assumed to be “q”. As is shown in FIG. 8a, when the angle between the direction from the center of the side surface 11s towards the center C11 of the first pressure applying surface 11c and the direction from the center of the side surface 12s towards the center C12 of the second pressure applying surface 12c (the top and bottom shift angle θv) is 180°, the shift “v” of the centers of the pressure applying surfaces will be twice the value of “q”.

In contrast with this, as is shown in FIG. 8b, if the top and bottom shift angle θv becomes less than 60°, the amount of shift caused by the top die 11 and the amount of shift caused by the bottom die 12 effectively cancel out each other and make the value of the shift of the centers of the pressure applying surfaces smaller than “q”. In addition, as is shown in FIG. 8c, when the top and bottom shift angle θv is 0°, the amount of shift “v” of the centers of the pressure applying surfaces becomes 0 by completely canceling out each other.

In this manner, in the method of manufacturing optical elements according to the present invention, it is desirable that the top and bottom shift angle θv is small, and it is particularly desirable that the top and bottom shift angle θv is less than 60° because the residual amount of shift of the optical axes in the manufactured optical element can be effectively reduced.

In order to make the top and bottom shift angle θv become less than 60°, it is sufficient to measure in advance using a microscope or the like, the direction from the center of the side surface 11s towards the center C11 of the first pressure applying surface 11c and the direction from the center of the side surface 12s towards the center C12 of the second pressure applying surface 12c. In addition, instead of directly measuring these directions, it is also possible to evaluate the performance of the manufactured optical element and to determine the relative positions of the top die 11 and the bottom die 12. For example, it is sufficient to relatively shift the top die 11 and the bottom die 12 every time by a fixed angle (an angle smaller than 60°, for example, 30° or 45°), prepare samples of optical elements at each of the angles, evaluate the performances of the samples (for example, the coma aberration), and to set to the angle at which the performance was best.

1. A molding die for manufacturing an optical element having two opposing optical surfaces by press molding of a glass material, the molding die comprising:
a top die having a first pressure applying surface for forming a first optical surface of the optical element;
a bottom die having a second pressure applying surface for forming a second optical surface opposite to the first optical surface;
a guiding member having a guiding surface which comes in contact with a side surface of the top die and a side surface of the bottom die at a time of the press molding of the glass material, and restricts relative positions of the top die and the bottom die on a plane which is perpendicular to a direction of pressure application to the glass material;
an expansion member for pressing the top die and the bottom die against the guiding surface due to thermal expansion caused by heating; and
a supporting member which supports the guiding member and the expansion member,
wherein, among thermal expansion coefficients of the top die, the bottom die, the guiding member, the expansion member and the supporting member, a thermal expansion coefficient of the expansion member is largest.

2. The molding die of claim 1,
wherein the supporting member is a cylindrical member having an internal peripheral surface, and the guiding member and the expansion member are supported by the internal peripheral surface of the supporting member.

3. The molding die of claim 1,
wherein one of the top die and the bottom die is a movable die which moves in the direction of pressure application to the glass material at the time of the press molding and another is a fixed die which does not move at the time of the press molding, the expansion member has a top expansion member for pressing the top die and a bottom expansion member for pressing the bottom die, and pressing force of pressing the movable die due to the thermal expansion of the expansion member is smaller than pressing force of pressing the fixed die.

4. The molding die of claim 1,
wherein the guiding member has another guiding surface which comes in contact with the side surface of the top die and the side surface of the bottom die at the time of the press molding, the guiding surface and the another guiding surface being positioned in a shape of a letter V.

5. The molding die of claim 1,
wherein the side surface of the top die and the side surface of the bottom die which come in contact with the guiding surface are cylindrical surfaces of substantially identical diameters.

6. The molding die of claim 5,
wherein the top die is one on which the first pressure applying surface is formed, among two die base materials obtained by cutting one cylindrical member, and the bottom die is another on which the second pressure applying surface is formed, among the two die base materials.

7. A manufacturing method of optical element for manufacturing an optical element having two opposing optical surfaces by press molding of a glass material using a molding die,
wherein the molding die is of claim 1, and the press molding is applied to the glass material in a condition in which the top die and the bottom die are pressed against the guiding surface of the guiding member due to the thermal expansion of the expansion member.

8. The manufacturing method of optical element of claim 7,
wherein an angle between a direction from a center of the side surface of the top die towards a center of the first pressure applying surface and a direction from a center of the side surface of the bottom die towards a center of the second pressure applying surface on the plane perpendicular to the direction of pressure application at the time of the press molding of the glass material is less than 60°.
